(19) United States
(12) Patent Application Publication
(10) Pub. No.: US 2026/0010433 A1
(43) Pub. Date: Jan. 8, 2026

(54) STORAGE SYSTEM AND DATA DIFFERENCE MANAGEMENT METHOD IN STORAGE SYSTEM

(71) Applicant: Hitachi Vantara, Ltd., Yokohama-shi (JP)

(72) Inventors: Chinami NISHIJIMA, Tokyo (JP); Hiroaki MIYATA, Tokyo (JP); Kahori SUGIHARA, Tokyo (JP); Tappei KATSUNAGA, Tokyo (JP)

(73) Assignee: Hitachi Vantara, Ltd., Yokohama-shi (JP)

(21) Appl. No.: 19/072,834

(22) Filed: Mar. 6, 2025

(30) Foreign Application Priority Data
Jul. 8, 2024 (JP) 2024-109854

(51) Int. Cl. G06F 11/10

(52) U.S. Cl. CPC G06F 11/1096

(57) ABSTRACT

The storage system manages difference information, by associating data blocks stored in a user area and a first parity and a second parity stored in a parity area of each of nodes, the difference information indicating presence or absence of a difference related to update of one or both of a data block and the second parity both belonging to the identical redundancy group of the data blocks, the first parity, and the second parity. The storage system manages, in a case where a data block stored in a user area of a closed node is updated, the difference information related to the update in one node that is not closed and is normally operating out of two nodes other than the closed node.

### BACKGROUND OF THE INVENTION

### 1. Field of the Invention

The present invention relates to a storage system and a data difference management method in the storage system.

### 2. Description of the Related Art

A storage system including a plurality of storage nodes is known. For example, the storage system is provided as a software defined storage (SDS) by executing predetermined software in each storage node (hereinafter, the node).

Examples of data protection schemes of this type of storage system include erasure coding (EC) and the like. For example, in a case where a failure occurs in a drive included in a node and the corresponding node is closed, rebuilding for recovering data of the failed drive is performed according to these data protection schemes.

Here, examples of the rebuilding include full rebuilding and differential rebuilding. By full rebuilding, all the data of the failed drive is restored from data stored in drives of other nodes other than a closed node having the failed drive. On the other hand, by differential rebuilding, only data updated by input output (IO) from the host received during closing of the node is restored. By the differential rebuilding, only differential data of the drive is rebuilt, and the data can be restored in a short time as compared with the full rebuilding.

JP 2023-106886 A discloses a method of differential rebuilding as described above.

### SUMMARY OF THE INVENTION

However, in the above-described conventional technique, there is a problem that data can be restored in a case where there is one closed node, while data cannot be restored in a case where there are two closed nodes.

The present invention has been made in view of the above problem, and an object of the present invention is to enable restoration of data by differential rebuilding even in a case where a drive failure occurs in two nodes in a storage system including a plurality of nodes.

In order to achieve the above object, according to an aspect of the present invention, there is provided a storage system including: four or more nodes each having a processor, a memory, and a storage drive, wherein for user data stored in the storage drive, a redundancy group including a plurality of data blocks of the user data and a first parity and a second parity based on the data blocks is configured, for each of the plurality of nodes, the storage drive of the corresponding node includes a user area that stores the plurality of data blocks belonging to different ones of the redundancy groups and a parity area that stores the second parity, and the processor is configured to: generate the second parity stored in the parity area of the corresponding node based on the first parity generated based on the plurality of data blocks belonging to the different redundancy groups stored in the user area of one of the nodes other than the corresponding node and on the plurality of data blocks belonging to an identical one of the redundancy groups stored in a distributed manner in the user areas of the plurality of nodes excluding the corresponding node and the one node; manages difference information, by associating the data blocks stored in the user area and the first parity and the second parity stored in the parity area of the corresponding node, the difference information indicating presence or absence of a difference related to update of one or both of the data block and the second parity both belonging to the identical redundancy group of the data blocks, the first parity, and the second parity of the corresponding node; and manages, in a case where the data block stored in the user area of the corresponding node is updated during a period in which the corresponding node is closed, the difference information related to the update in one node that is not closed and is normally operating out of two nodes other than the corresponding node.

According to the present invention, in a storage system including a plurality of nodes, even in a case where a failure of a drive occurs in two nodes, data can be restored by differential rebuilding.

### BRIEF DESCRIPTION OF THE DRAWINGS

FIG. 1 is a diagram illustrating an example of a physical configuration of a storage system according to a first embodiment;

FIG. 2 is a diagram illustrating an example of a logical configuration of the storage system according to the first embodiment;

FIG. 3 is a diagram illustrating an example of information in a memory according to the first embodiment;

FIG. 4A is a diagram illustrating an example of a difference management table according to the first embodiment;

FIG. 4B is a diagram illustrating an example of a difference management table according to the first embodiment;

FIGS. 5A-5B are a diagram illustrating an example of a stripe configuration in a parity group according to the first embodiment;

FIG. 6 is a diagram illustrating an example of a relationship among a data block, a C1 parity block, and a PQ parity block according to the first embodiment;

FIG. 7 is a diagram illustrating an example of an outline of processing related to differential rebuilding according to the first embodiment;

FIG. 8 is a diagram illustrating an example of an outline of difference information recording processing at the time of one-node closure according to the first embodiment;

FIG. 9 is a diagram illustrating an example of an outline of difference information collection processing and difference information reflection processing at the time of two-node closure according to the first embodiment;

FIG. 10 is a diagram illustrating an example of an outline of difference information clear processing at the time of node recovery according to the first embodiment;

FIG. 11A is a timing chart illustrating an example of differential rebuilding processing at the time of two-node failure according to the first embodiment;

FIG. 11B is a timing chart illustrating an example of differential rebuilding processing at the time of two-node failure according to the first embodiment;

FIG. 12A is a timing chart illustrating an example of differential rebuilding processing at the time of two-node failure according to a second embodiment;

FIG. 12B is a timing chart illustrating an example of differential rebuilding processing at the time of two-node failure according to a second embodiment; and

FIG. 12C is a timing chart illustrating an example of differential rebuilding processing at the time of two-node failure according to a second embodiment.

### DESCRIPTION OF THE PREFERRED EMBODIMENTS

In the following description, an “interface apparatus” may be one or more communication interface devices. The one or more communication interface devices may be one or more communication interface devices of the same type (for example, one or more network interface cards (NIC)) or two or more communication interface devices of different types (for example, an NIC and a host bus adapter (HBA)).

In the following description, a “memory” is one or more memory devices that are an example of one or more storage devices, and may typically be a main storage device. The at least one memory device in the memory may be a volatile memory device or a non-volatile memory device.

In addition, in the following description, a “permanent storage apparatus” may be one or more permanent storage devices that are an example of one or more storage devices. Typically, the permanent storage device may be a non-volatile storage device (for example, an auxiliary storage device), and specifically, for example, may be a hard disk drive (HDD), a solid state drive (SSD), or a non-volatile memory express (NVMe) drive.

In the following description, a “processor” may be one or more processor devices. The at least one processor device may typically be a microprocessor device such as a central processing unit (CPU), but may be another type of processor device such as a graphics processing unit (GPU). The at least one processor device may be a single core or a multi-core. The at least one processor device may be a processor core. The at least one processor device may be a processor device in a broad sense such as a hardware circuit that performs a part or all of processing (for example, a field-programmable gate array (FPGA), a complex programmable logic device (CPLD), or an application specific integrated circuit (ASIC)).

In addition, in the following description, information in which an output is obtained by an input may be described by an expression such as “xxx table”. However, the information may be data of any structure (for example, may be structured data or unstructured data), or may be a learning model represented by a neural network, a genetic algorithm, or a random forest that generates an output for an input. Therefore, the “xxx table” can be referred to as “xxx information”. In the following description, configurations of respective tables are examples, and one table may be divided into two or more tables, or all or a part of two or more tables may constitute one table.

In the following description, processing may be described with a “program” as a subject. However, the program is executed by the processor to perform predetermined processing while appropriately using the storage apparatus and/or the interface apparatus. Therefore, the subject of the processing may be the processor (alternatively, a device such as a controller having the processor). The program may be installed in a device such as a computer from a program source. The program source may be, for example, a program distribution server or a computer-readable (for example, non-transitory) recording medium. In the following description, two or more programs may be implemented as one program, or one program may be implemented as two or more programs.

In the embodiment described below, it is assumed that the storage system includes six nodes. In addition, it is assumed that a multi-stage erasure coding (MEC), which is a type of 4D+2P EC in which two parities (C1 parity and PQ parity) are provided for every four data blocks in correspondence with the number of nodes of the storage system of six, is adopted as a data protection scheme in the storage system. However, the number of nodes is not limited to six, and the data protection scheme is not limited to 4D+2P. That is, the MEC of mD+nP may be adopted in a storage system having nodes of (m+n) or more (m is an integer of 2 or more, and n is an integer of 2 or more).

### First Embodiment

### (Physical Configuration of Storage System 101)

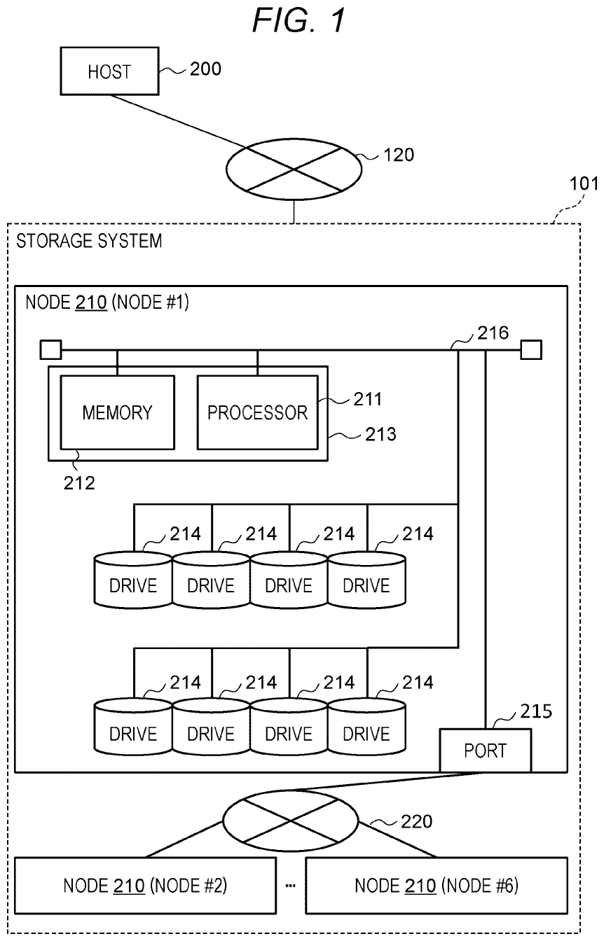

FIG. 1 illustrates an example of a physical configuration of a storage system 101.

The storage system 101 includes a plurality of nodes 210. In the present embodiment, it is assumed that the storage system 101 includes six of the nodes 210. The storage system 101 includes an interface (not illustrated) for connecting to a network 120, and is communicably connected to a host 200 via the network 120.

Each of the nodes 210 may have a configuration of a general server computer. The node 210 includes, for example, at least one processor package 213, at least one drive 214, and at least one port 215. The components are connected via an internal bus 216. The processor package 213 includes a processor 211, a memory 212, and the like. The drive 214 is an example of the storage drive and the permanent storage apparatus. The port 215 is an example of the interface apparatus.

The processor 211 is, for example, a CPU, and performs various types of processing. The processor 211 performs the various types of processing in cooperation with another processor 211 included in another node 210 other than the node 210 including the own processor.

The memory 212 stores control information necessary for realizing a function of the node 210 and stores data. In addition, the memory 212 stores, for example, a program executed by the processor 211. The memory 212 may be a volatile dynamic random access memory (DRAM), a non-volatile SCM, or another type of storage device.

The drive 214 stores various data, programs, and the like. The drive 214 may be an HDD or an SSD connected with Serial Attached SCSI (SAS) or Serial Advanced Technology Attachment (SATA), an SSD connected with NVMe, an SCM, or the like, and is an example of the storage device.

The port 215 is connected to a network 220 and is communicably connected to another node 210 in a site 201. The network 220 is, for example, a local area network (LAN), but is not limited to the LAN.

The physical configuration of the storage system 101 is not limited to the above example. For example, the network 220 may be redundant. In addition, for example, the network 220 may be separated into a management network and a storage network, the connection standard may be Ethernet (registered trademark), InfiniBand (registered trademark), or wireless, and the connection topology is not limited to the configuration illustrated in FIG. 1.

### (Logical Configuration of Storage System 101)

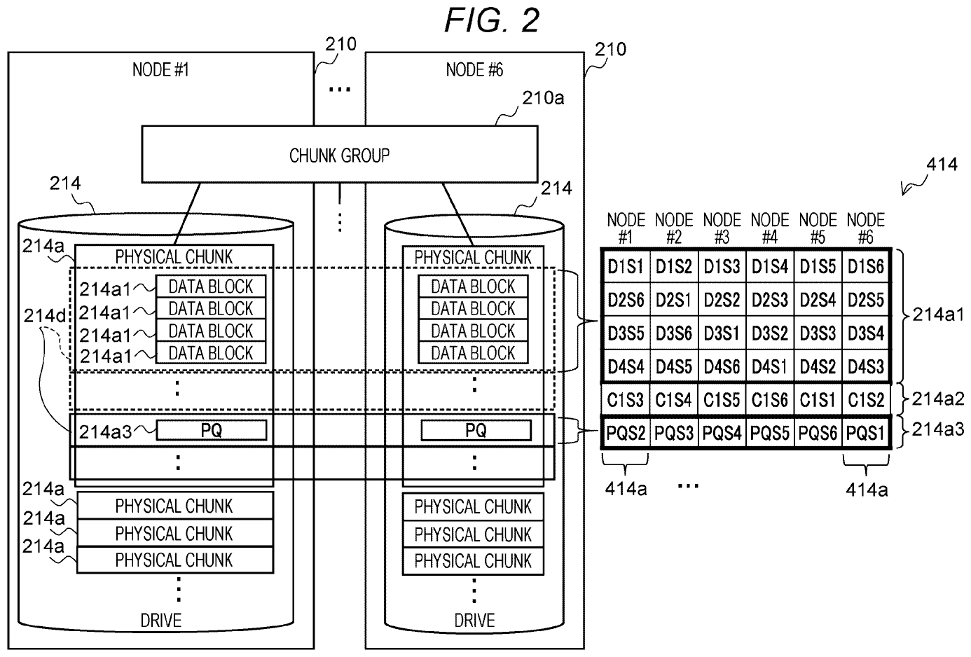

FIG. 2 illustrates an example of a logical configuration of the storage system 101.

The drive 214 of each node 210 included in the storage system 101 includes a plurality of physical chunks 214a. Each of the physical chunks 214a is an area obtained by cutting out a storage area of user data of each drive 214, and includes a plurality of data blocks 214a1 and a plurality of parity blocks 214a3. In the present embodiment, one parity block 214a3 is associated with four data blocks 214a1. A storage area for the data blocks 214a1 of the physical chunk 214a is referred to as a user area, and a storage area for the parity blocks 214a3 is referred to as a parity area.

Each of the data block 214a1 is a storage area serving as a unit for storing user data. Each of the parity blocks 214a3 is an area for storing P+Q parity of the corresponding four data blocks 214a1, but may store a different parity, not limiting to the P+Q parity.

A chunk group 210a is a combination in which one physical chunk 214a is taken out and combined for each node 210. The four data blocks 214a1 and the one parity block 214a3 are extracted and combined for each physical chunk 214a belonging to the chunk group 210a, and thus a parity group 214d is constituted.

A difference information management table 414 is provided for each parity group 214d. The difference information management table 414 is obtained by arranging pieces of difference information 414a in each of which the four data blocks 214a1 and the one parity block 214a3 are arranged in a vertical direction for each node 210 in a horizontal direction for all the nodes 210 belonging to the same chunk group 210a. In the example illustrated in FIG. 2, blocks D1S1, D2S6, D3S5, D4S4, C1S3, and PQS2 are arranged and stored in this order in the column of a node #1 in the difference information management table 414. The columns of nodes #2, #3, #4, #5, and #6 in the difference information management table 414 are also as illustrated in FIG. 2.

### (Information in Memory 212)

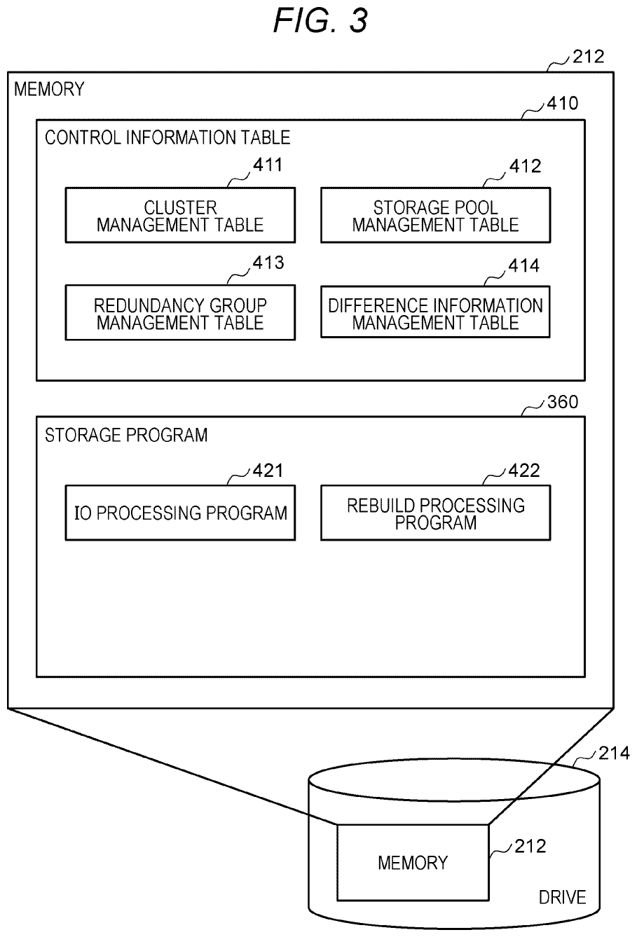

FIG. 3 illustrates an example of information in the memory 212.

The information in the memory 212 including a control information table 410 and a storage program 360 is read from a non-volatile storage area, such as the drive 214, to the memory 212, and executed by the processor 211.

The control information table 410 includes a cluster management table 411, a storage pool management table 412, a parity group management table 413, and the difference information management table 414.

The cluster management table 411 stores information for managing the configurations of the storage system 101, the node 210, and the drive 214. The storage pool management table 412 stores control information for a thin provisioning function provided by a storage pool. The storage pool is configured to include a plurality of logical chunks corresponding to the data blocks 214a1 of the physical chunk 214a, and virtualizes the capacity of the storage system 101 as a whole.

The parity group management table 413 stores control information for managing the configuration of the parity group 214d (redundancy group) configured by combining the plurality of physical chunks 214a. Details of the cluster management table 411, the storage pool management table 412, and the parity group management table 413 are omitted.

The difference information management table 414 is a table for managing the pieces of difference information each indicating presence or absence of a difference related to update of each block of data/parity stored in the nodes 210 of the storage system 101. Details of the difference information management table 414 will be described later.

The storage program 360 includes an IO processing program 421 and a rebuild processing program 422. The IO processing program 421 processes an IO from the host 200 (FIG. 1). Details of the rebuild processing program 422 will be described later.

### (Difference Information Management Table 414)

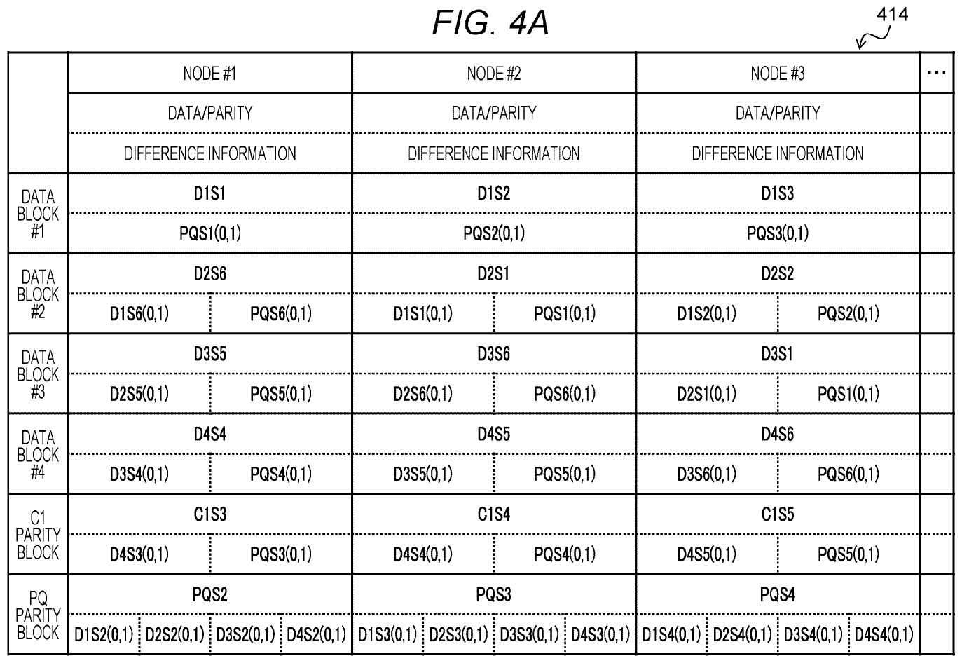

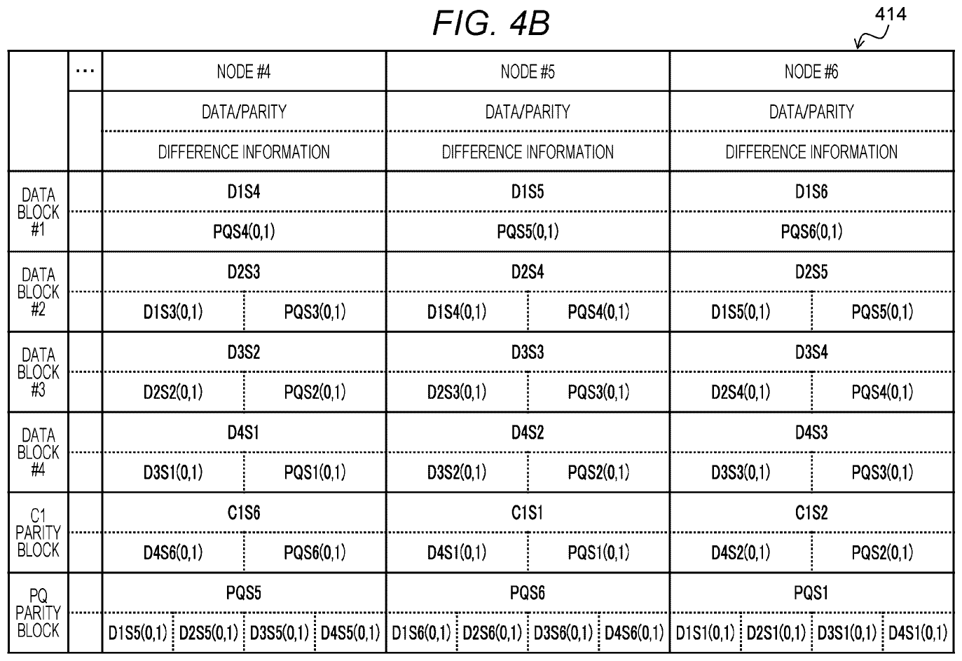

FIGS. 4A and 4B are diagrams illustrating the difference information management table 414 for explaining a difference management method in the storage system 101. FIG. 4A illustrates a portion of the difference information management table 414 for the nodes 210 (the nodes #1 to #3), and FIG. 4B illustrates a portion of the difference information management table 414 for the nodes 210 (the nodes #4 to #6).

The difference information management table 414 has columns of “data/parity” and “difference information” for each of the nodes #1 to #6. The difference information management table 414 also has rows of data blocks #1 to #4, a C1 parity block, and a PQ parity block.

The difference information management table 414 has “data/parity” in an upper row and the “difference information” in a lower row for each parity group 214d and each of the nodes #1 to #6. In the present embodiment, the difference information management table 414 stores pieces of difference information each indicating whether or not a block of data/parity stored in another node 210 in association with “data/parity” illustrated in the upper row stored in each node 210 is a target of differential rebuilding.

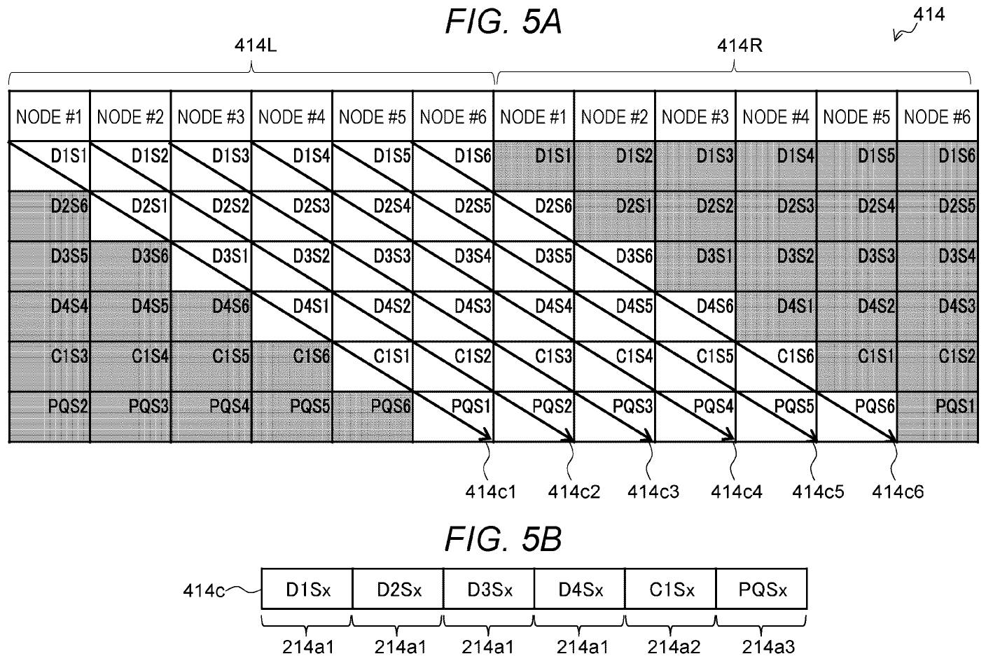

Here, a stripe 414c in the parity group 214d will be described. FIG. 5 is a diagram illustrating an example of a configuration of the stripe 414c in the parity group 214d. In FIG. 5A, identical difference information management tables 414L and 414R are arranged side by side for convenience of description. Components below a diagonal line (line segment connecting D1S1, D2S1, D3S1, D4S1, C1S1, and PQS1) of the difference information management table 414L are displayed in the difference information management table 414R.

As illustrated in FIG. 5B, the stripe 414c includes the four data blocks 214a1, the one C1 parity block 214a2, and the one parity block 214a3. The stripe 414c includes, for example, six stripes 414c1, 414c2, 414c3, 414c4, 414c5, and 414c6 as illustrated in FIG. 5A.

The stripe 414c1 (stripe S1) includes D1S1 of the node #1, D2S1 of the node #2, D3S1 of the node #3, D4S1 of the node #4, C1S1 of the node #5, and PQS1 of the node #6. DiS1 (i=1, 2, . . . , 4) is the data block 214a1 of the stripe S1. C1S1 is the C1 parity block, and is an XOR of the data blocks D1S1, D2S6, D3S5, and D4S4 in the node #1. PQS1 is the PQ parity block of the stripe S1. The stripes S2 to S6 are similar to the stripe S1.

Hereinafter, DiSj (i=1, . . . , 4, j=1, . . . , 6) is expressed as Di of the Sj stripe. In addition, C1Sj (j=1, . . . , 6) is expressed as C1 of the Sj stripe. Further, PQSj (j=1, . . . , 6) is expressed as PQ of the Sj stripe.

The stripe 414c2 (stripe S2), the stripe 414c3 (stripe S3), the stripe 414c4 (stripe S4), the stripe 414c5 (stripe S5), and the stripe 414c6 (stripe S6) are also as illustrated in FIG. 5.

The description returns to FIGS. 4A and 4B. In an intersecting portion between each row and each column of the difference information management table 414, information as illustrated in FIGS. 4A and 4B is stored.

For example, in an intersecting portion between a row of data block #1 and a column of node #1 in the difference information management table 414, D1S1 (D1 of the stripe S1) is stored in “data/parity”, and PQS1 (0,1) is stored in “difference information”. In “PQS1 (0,1)”, “1” is stored if there is a difference in PQS1 (PQ of the stripe S1), and “0” is stored if there is no difference.

In addition, in an intersecting portion between a row of data block #1 and a column of node #1 in the difference information management table 414, D2S6 (D2 of the stripe S6) is stored in “data/parity” and D1S6 (0,1) and PQS6 (0,1) are stored in “difference information”. In “D1S6 (0,1)”, “1” is stored if there is a difference in D1S6 (D1 of the stripe S6), and “0” is stored if there is no difference. In “PQS6 (0,1)”, “1” is stored if there is a difference in PQS6 (PQ of the stripe S6), and “0” is stored if there is no difference.

PQS2 (PQ of the stripe S2) is stored in “data/parity” in an intersecting portion between the row of the PQ parity block and the column of the node #1 in the difference information management table 414. In addition, D1S2 (0,1), D2S2 (0,1), D3S2 (0,1), and D4S2 (0,1) are stored in the “difference information”. In the “PQS2 (0,1)”, “1” is stored if there is a difference in PQS2 (PQ of the stripe S2), and “0” is stored if there is no difference. In “DiS2 (0,1)” (i=1, 2, . . . , 4), “1” is stored if there is a difference in DiS2 (Di of the stripe S2), and “0” is stored if there is no difference.

The C1 parity block and the C1 parity are examples of a first parity. The PQ parity block and the PQ parity are examples of a second parity.

In the MEC, for example, in a case where the data block “D1S1” stored in the node 210 (node #1) is updated, the following two blocks are simultaneously updated. That is, the PQ parity block “PQS1” of the same stripe S1 and the PQ parity block “PQS3” of the same stripe S3 as the C1 parity block “C1S3” of the node 210 (node #1) are simultaneously updated. That is, in a case where the data block “D1S1” stored in the node 210 (node #1) is updated, the node 210 (node #2) and the node 210 (node #6) are simultaneously accessed.

Therefore, it is preferable for efficient data access that one piece of difference information of the data block “D1S1” is stored in association with the PQ parity block “PQS1” stored in the node 210 (node #6).

Furthermore, in the present embodiment, in order to cope with a failure of two of the nodes 210, the difference information of one data/parity is stored in two places. Therefore, the other piece of the difference information is preferably stored in association with the data/parity stored in the node 210 (node #2) for efficient data access. Therefore, the other piece of the difference information is stored in association with the data block “D2S1” which is a block of data/parity of the stripe S1 stored in the node 210 (node #2).

### (Relationship Between Blocks of Data/Parity)

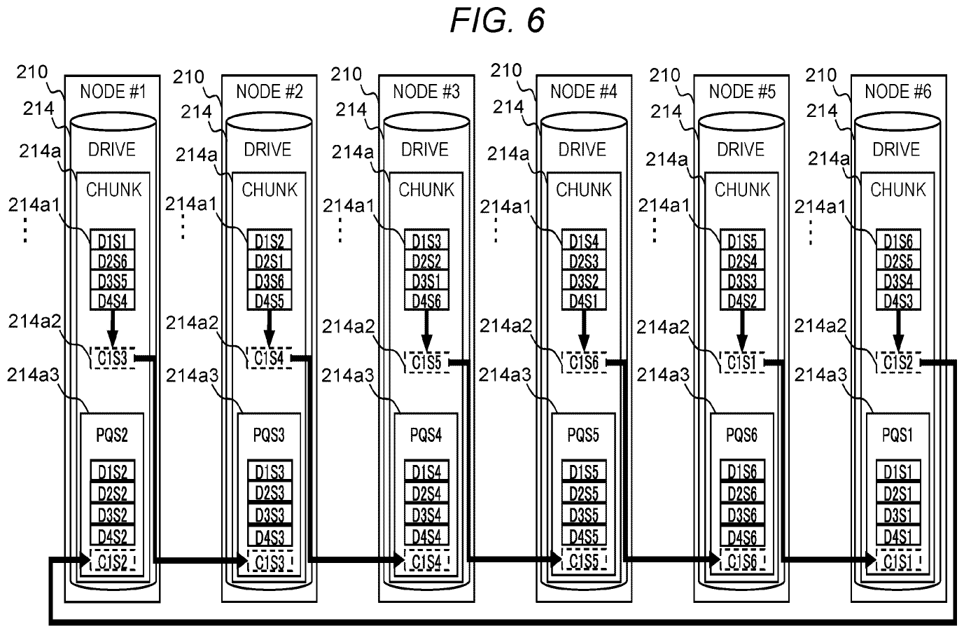

FIG. 6 is a diagram illustrating an example of a relationship among the data blocks 214a1, the C1 parity block 214a2, and the parity block 214a3.

As illustrated in FIG. 6, C1S3 of the node #1 is generated by performing an XOR operation on D1S1, D2S6, D3S5, and D4S4 stored in the node #1. The actual data of C1S3 is not stored in the drive 214 but is held in the memory 212. PQS3 stored in the node #2 is a PQ parity calculated based on D1S3 stored in the node #3, D2S3 stored in the node #4, D3S3 stored in the node #5, D4S3 stored in the node #6, and C1S3.

C1S4 and PQS4, C1S5 and PQS5, C1S6 and PQS6, and C1S1 and PQS1 are similarly calculated as illustrated in FIG. 6.

As described above, in the present embodiment, the data and the PQ parity of the same stripe Sx (x=1, 2, . . . , 4) are arranged in a distributed manner in all the nodes 210 (nodes #1 to #6). As a result, at the time of one-node failure in one node 210, the data and the PQ parity stored in the failed node can be restored by full rebuilding or differential rebuilding based on the data and the PQ parity arranged in a distributed manner in the other nodes 210.

In addition, in a case of two-node failure in which failure in another node 210 occurs at the time of the above-described one-node failure, the C1 parity of the same stripe Sx as the data block that cannot be acquired due to the node failure is used instead of the data block that cannot be acquired. As a result, at the time of two-node failure of the node 210, the data and the PQ parity stored in the failed node can be restored by full rebuilding or differential rebuilding based on the data, the C1 parity, and the PQ parity arranged in a distributed manner in the other nodes 210.

In addition, the difference information of data/parity of each node 210 is held in two other nodes 210 which are simultaneously accessed at the time of data update of the corresponding node 210 in which data to be updated is stored. As a result, even at the time of two-node failure in which a failure occurs in the corresponding node 210 and the other one of the nodes 210, the difference information is held in the remaining one of the other nodes 210 and is not lost, and the data and the PQ parity can be restored by the differential rebuilding.

### (Timing of Each Processing Related to Differential Rebuilding)

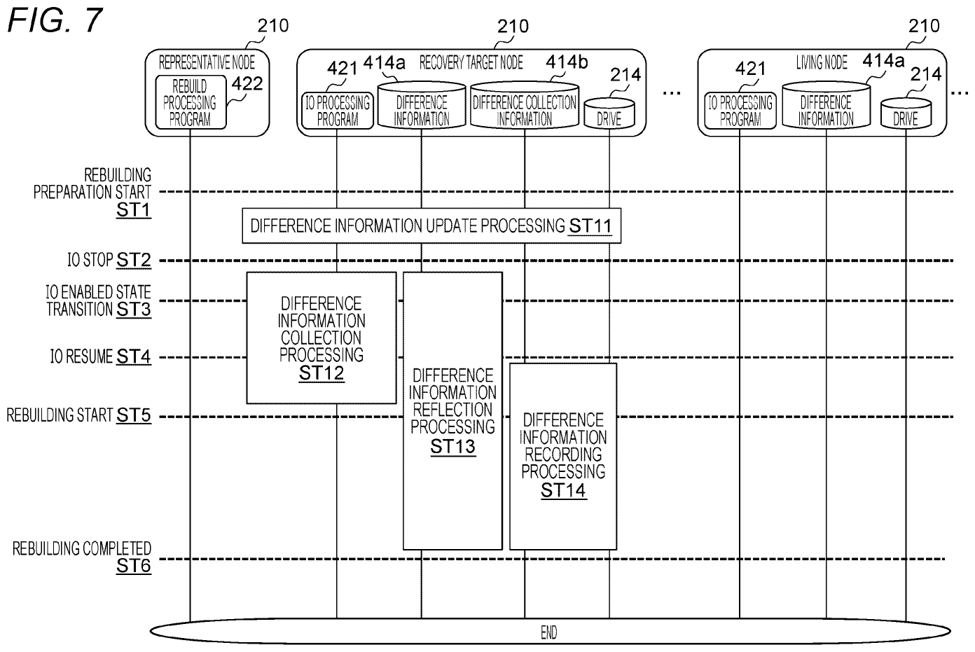

FIG. 7 is a diagram illustrating an example of an outline of processing related to differential rebuilding.

In the differential rebuilding in the present embodiment, similarly to the differential rebuilding of the related art, difference information update processing ST11 during recovery of the node 210 closed by the drive failure (recovery target node) is executed from rebuilding preparation start ST1 to IO stop ST2 before rebuilding starts.

This is for the following reason. In order to perform differential rebuilding, it is necessary to collect difference information from the node 210 (living node) that is operating normally. At this time, it is necessary to prevent the passing between update for the node 210 (living node) holding the difference information and collection of the difference information (difference information collection processing ST12) so as prevent failure in collection of the difference information. The living node is a node that is not closed and is operating normally.

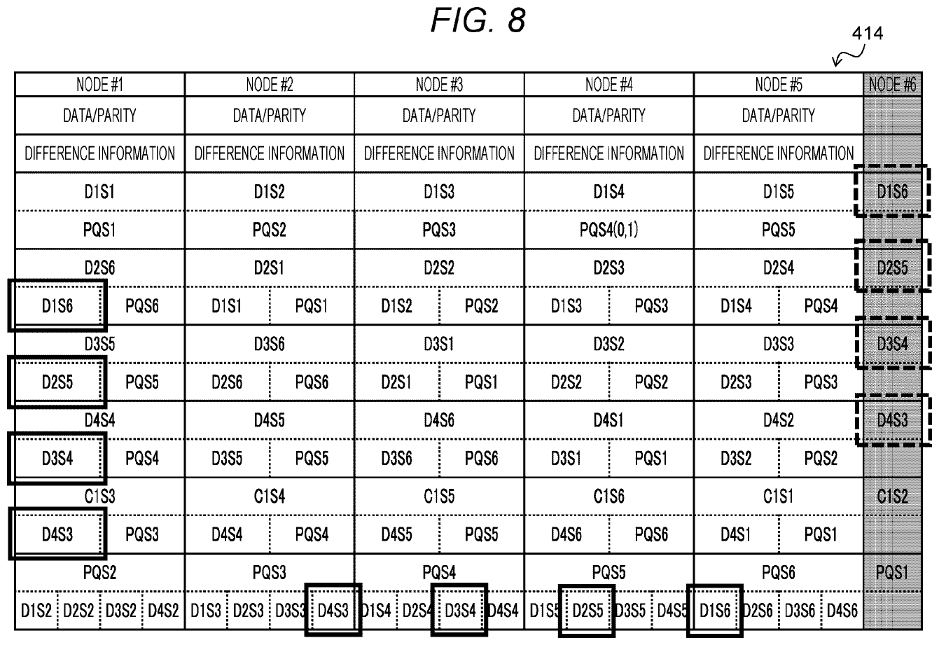

FIG. 8 is a diagram illustrating an example of an outline of difference information recording processing at the time of one-node closure according to the first embodiment. The node closure indicates a state in which that the node 210 fails to receive an IO from the host 200 due to a failure or the like of the drive 214 included in the corresponding node 210.

As illustrated in FIG. 8, for example, when the node #6 is closed, update information related to D1S6 of the node #6 is held in the node #1 and the node #6. In addition, when the node #6 is closed, update information related to D2S5 of the node #6 is held in the node #1 and the node #4. Further, when the node #6 is closed, update information for D3S4 of the node #6 is held in the node #1 and the node #3. Further, when the node #6 is closed, update information for D4S3 of the node #6 is held in the node #1 and the node #2.

The IO is stopped at the IO stop ST2, and the configuration of the configuration information of the node 210 (recovery target node) is completed in IO enabled state transition ST3. When the configuration of the configuration information is completed, the node 210 (recovery target node) can perform IO at IO resume ST4, and therefore the difference information update processing ST11 is not performed thereafter.

Next, the difference collection information collected by the difference information collection processing ST12 is reflected to the node 210 (recovery target node). This is because the node 210 (recovery target node) also becomes a target of collection of the difference information after the recovery, and differential rebuilding is performed to the other nodes 210 (recovery target nodes) based on the difference collection information collected from the node 210 (recovery target node) that has been previously recovered.

In the present embodiment, the difference information of “data/parity” is held in the other two nodes 210 other than the own node 210 in which “data/parity” is stored. For example, in a case where the node 210 that is a target of collection of the difference information and is operating normally is newly closed during recovery of one node 210, the difference information is lost unless the difference information obtained while the recovered node 210 has been closed is reflected in the recovered node 210.

Therefore, the difference information collection processing ST12 is performed after the IO stop ST2 and before rebuilding start ST5 and in a state where the differential update of the node that is being recovered is not performed.

Since the difference information is required for the differential rebuilding, the difference information is collected before the execution of the differential rebuilding. This is because, in a case where the difference information is collected in a state where the difference information update processing ST11 of the node 210 that is being recovered is performed, there is a possibility that the difference information necessary for the differential rebuilding cannot be completely collected due to passing between the difference information update processing ST11 and the collection of the difference information.

Further, difference information reflection processing ST13 is performed before the node 210 that is being recovered is completely recovered. This is for the following reason. After the rebuilding is completed, it is possible to cope with the closure of another node 210, since the redundancy is recovered. However, if the difference information reflection processing ST13 is not performed, when another node 210 is closed and recovery is started, there is no difference information to be reflected to the closed node 210 in any node 210. When the node 210 to which the recovery has started in this state performs the difference information collection processing ST12, differential rebuilding cannot be performed because there is difference information that has not been reflected.

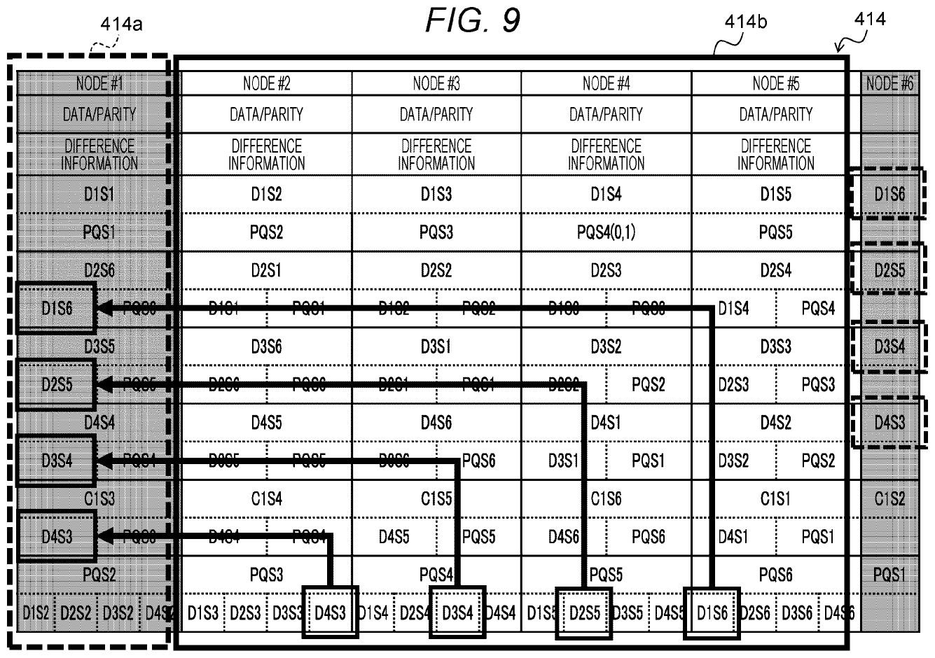

FIG. 9 is a diagram illustrating an example of an outline of the difference information collection processing ST12 and the difference information reflection processing ST13 at the time of two-node closure according to the first embodiment. FIG. 9 illustrates a case of recovery processing of the node #1 at the time of two-node closure due to failures in the nodes #1 and #6.

Since the difference information of D1S6 of the node #6 is managed by the node #1 and the node #5, the difference information of D1D6 is collected as the difference collection information 414b from the node #5 and reflected to the difference information 414a of the node #1 at the time of recovery of the node #1. In addition, since the difference information of D2S5 of the node #6 is managed by the node #1 and the node #4, the difference information of D2D5 is collected as the difference collection information 414b from the node #4 and reflected to the difference information 414a of the node #1 at the time of recovery of the node #1. Further, since the difference information of D3S4 of the node #6 is managed by the node #1 and the node #3, the difference information of D3S4 is collected as the difference collection information 414b from the node #3 and reflected to the difference information 414a of the node #1 at the time of recovery of the node #1. Moreover, since the difference information of D4S3 of the node #6 is managed by the node #1 and the node #2, the difference information of D4D3 is collected as the difference collection information 414b from the node #2 reflected to the difference information 414a of the node #1 at the time of recovery of the node #1.

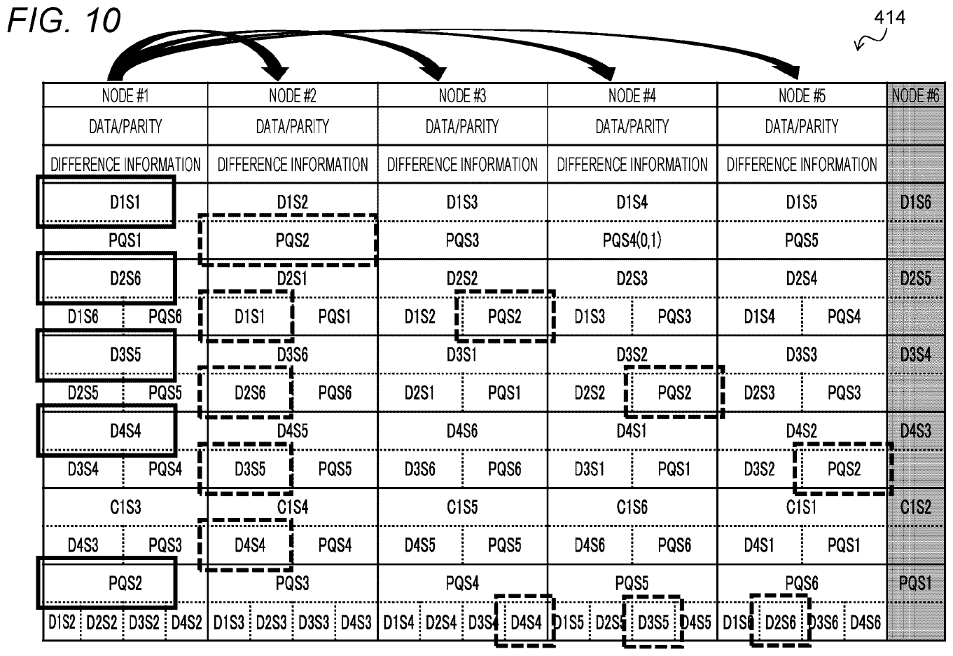

FIG. 10 is a diagram illustrating an example of an outline of difference information clear processing at the time of node recovery according to the first embodiment. Upon completion of the difference information reflection processing ST13, as illustrated in FIG. 10, a notification indicating that the node #1 has recovered is transmitted from the recovered node #1 to the nodes #2 to #5 that are the living nodes in the normal operation. Upon reception of the notification that the node #1 has recovered, the nodes #2 to #5 specify the difference information to be cleared in each node (a portion surrounded by a broken line specified from a block surrounded by a solid line in FIG. 10) based on the stripe relationship, and only the specified difference information is cleared.

When rebuilding can be started again, the node 210 to be recovered also starts recording of a difference (difference information recording processing ST14). In order to perform differential rebuilding at the time of recovery of the closed node 210, it is necessary to record the difference due to update of the closed node even during the node recovery. In a case where the difference information recording processing ST14 is not performed during the node recovery and another node 210 holding the difference is newly closed, the difference updated during the node recovery is not held. For this reason, in a case where an attempt is made to recover the node 210 which is originally closed, an area where differential rebuilding is not performed occurs, and the differential rebuilding is not performed correctly.

Therefore, if there is an update in the closed node after the IO resume ST4, there is an access to parity update to the recovery node, and thus the difference information of the recovery node is held.

### (Differential Rebuilding Processing at the Time of Two-Node Failure)

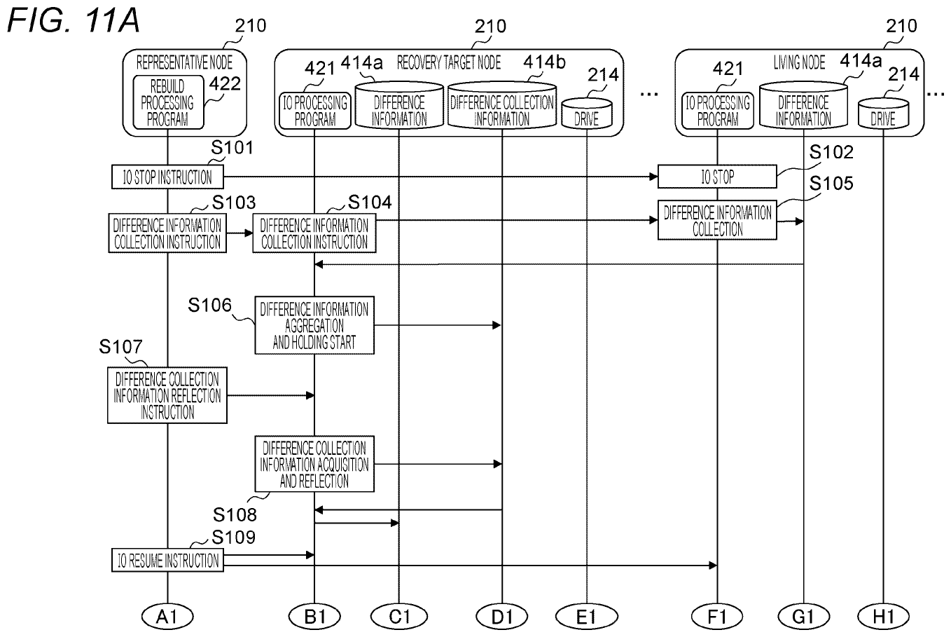

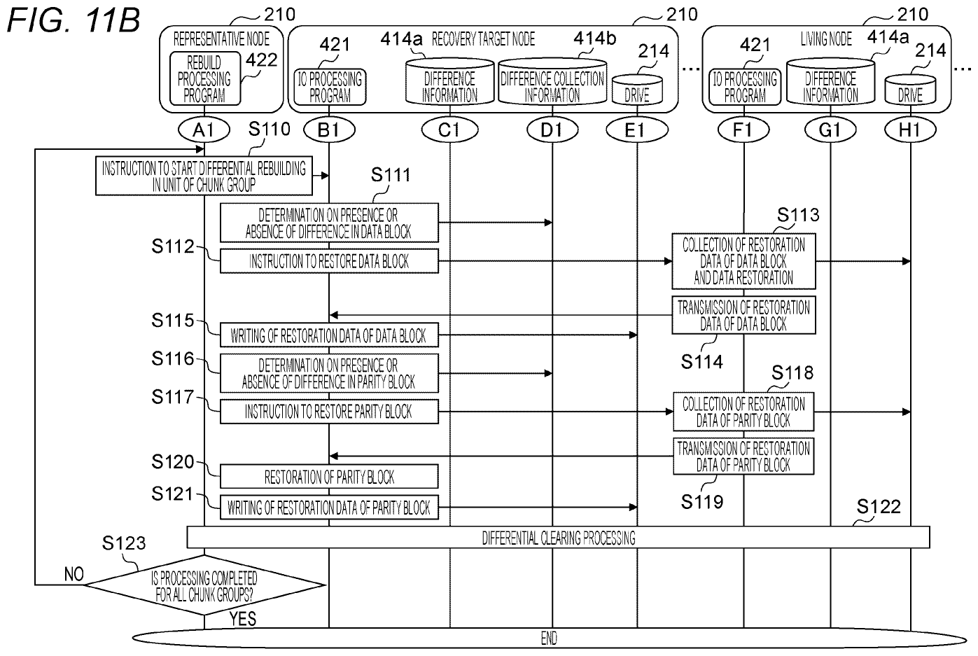

FIGS. 11 A and 11B are timing charts illustrating an example of differential rebuilding processing at the time of two-node failure. In the description of FIGS. 11 A and 11B, an example in which failures occur in two nodes 210 in the storage system 101 and the recovery target nodes 210 (recovery target nodes) are sequentially recovered one by one will be described. In FIGS. 11 A and 11B, only one of the nodes 210 (recovery target nodes) to be sequentially recovered is illustrated. A series of processing illustrated in FIGS. 11A and 11B is sequentially executed for each of the recovery target nodes 210 (recovery target nodes).

The differential rebuilding processing is executed by the rebuild processing program 422 of the node 210 (representative node) as a representative in the storage system 101 in cooperation with the IO processing programs 421 of the other nodes 210 (living nodes) and the node 210 (recovery target node). The nodes 210 (living nodes) are nodes in which no failure has occurred and normal operation is continued.

Note that the difference information 414a included in each of the nodes 210 illustrated in FIGS. 11 A and 11B is the difference information stored in the difference information management table 414 managed by the own node 210. The difference collection information 414b included in the node 210 (recovery target node) is the difference information stored in the difference information management table 414 managed by another node 210 other than the own node.

First, in step S101 of FIG. 11A, the rebuild processing program 422 instructs the IO processing programs 421 of all the nodes 210 (living nodes) to the IO stop for stopping the processing of the IO from the host 200. Next, in step S102, the IO processing programs 421 of all the nodes 210 (living nodes) stop the IO in response to the instruction in step S101.

Next, in step S103, the rebuild processing program 422 instructs the IO processing program 421 of the node 210 (recovery target node) to collect the difference information. Next, in step S104, the IO processing program 421 of the node 210 (recovery target node) instructs the IO processing program 421 of the nodes 210 (living nodes) to collect the difference information.

Next, in step S105, the IO processing programs 421 of the nodes 210 (living nodes) acquire and transmit the difference information 414a to the IO processing program 421 of the node 210 (recovery target node).

Next, in step S106, the IO processing program 421 of the node 210 (recovery target node) aggregates the difference information received from the nodes 210 (living nodes) as the difference collection information 414b and stores this information in the memory 212. In step S106, holding of the difference information necessary for rebuilding is started.

Next, in step S107, the rebuild processing program 422 instructs the IO processing program 421 of the node 210 (recovery target node) to reflect the difference collection information. Next, in step S108, the IO processing program 421 of the node 210 (recovery target node) acquires the difference collection information 414b and reflects this information to the difference information 414a. After step S108, if there is another closed node in the storage system 101, recording of the difference information of the closed node is started.

Next, in step S109, the rebuild processing program 422 instructs the node 210 (recovery target node) and all the nodes 210 (living nodes) to resume IO. The node 210 (recovery target node) and all the nodes 210 (living nodes) resume IO in response to the instruction. Since the configuration information is reconfigured during the IO stop, the node 210 (recovery target node) can perform IO at the same time as timing of the IO resume of the nodes 210 (living nodes).

Next, in step S110 of FIG. 11B, the rebuild processing program 422 instructs the IO processing program 421 of the node 210 (recovery target node) to start differential rebuilding in unit of the chunk group 210a.

Next, in step S111, the IO processing program 421 of the node 210 (recovery target node) refers to the difference collection information 414b, and determines whether or not there is a difference in the data blocks 214a1 for the chunk group 210a designated in step S110. For the data block 214a1 having no difference, the data stored in the drive 214 of the node 210 (recovery target node) can be used as it is, and therefore the IO processing program 421 of the node 210 (recovery target node) skips steps S113 to S115.

Next, in step S112, the IO processing program 421 of the node 210 (recovery target node) instructs the IO processing programs 421 of the nodes 210 (living nodes) to restore the data block 214a1 determined to have a difference in step S111 by differential rebuilding.

Next, in step S113, the IO processing programs 421 of the nodes 210 (living nodes) refer to the drives 214, collect restoration data for restoring the data block 214a1 instructed to be restored in step S112 by differential rebuilding, and restores the data. The collection of the restoration data is referred to as collection copy.

Next, in step S114, the IO processing programs 421 of the nodes 210 (living nodes) transmit the restoration data restored in step S113 to the IO processing program 421 of the node 210 (recovery target node) which is the instruction source of the data restoration in step S112.

Next, in step S115, the IO processing program 421 of the node 210 (recovery target node) writes the restoration data (data block 214a1) received from the IO processing programs 421 of the nodes 210 (living nodes) to the drive 214. After step S115, the restoration data is held in the drive 214.

Steps S112 to S115 are repeated as long as there is a difference in the data blocks 214a1.

Next, in step S116, the IO processing program 421 of the node 210 (recovery target node) refers to the difference collection information 414b and determines whether or not there is a difference in the parity blocks 214a3 for the chunk group 210a designated in step S110. For the parity block 214a3 having no difference, the PQ parity stored in the drive 214 of the node 210 (recovery target node) can be used as it is, and therefore the IO processing program 421 of the node 210 (recovery target node) skips steps S117 to S121.

Next, in step S117, the IO processing program 421 of the node 210 (recovery target node) instructs the IO processing programs 421 of the nodes 210 (living nodes) to perform data restoration of the parity block 214a3 determined to have a difference by differential rebuilding.

Next, in step S118, the IO processing programs 421 of the nodes 210 (living nodes) refer to the drive 214 and collect restoration data (collection-copies) for restoring the parity block 214a3 instructed to be restored in step S117. Next, in step S119, the IO processing programs 421 of the nodes 210 (living nodes) transmit the restoration data collected in step S118 to the IO processing program 421 of the node 210 (recovery target node) which is the instruction source of the data restoration in step S117.

Next, in step S120, the IO processing program 421 of the node 210 (recovery target node) restores the parity block 214a3 based on the restoration data received from the IO processing programs 421 of the nodes 210 (living nodes). Next, in step S121, the IO processing program 421 of the node 210 (recovery target node) writes the restoration data restored in step S120 to the drive 214.

Steps S117 to S121 are repeated as long as there is a difference in the parity blocks 214a3.

Next, in step S122, the rebuild processing program 422 as well as the IO processing programs 421 of the node 210 (recovery target node) and the nodes 210 (living nodes) execute differential clearing processing at the timing of completion of the differential rebuilding. In the differential clearing processing, a notification indicating which node 210 has been recovered is transmitted from the node 210 (recovery node) to each node 210. Each node 210 that has received the notification specifies the data block 214a1 from which the difference information is to be cleared from the stripe relationship, and clears the associated difference information. In the differential clearing processing, only the difference information of the recovered node 210 is cleared, and the difference information of the node 210 in the block that has not yet recovered is maintained.

In the node recovery processing from the two-node closure, by clearing only the difference information related to the node 210 that has first recovered, the differential rebuilding can be executed also in the recovery processing of the second node 210.

Next, in step S123, the rebuild processing program 422 determines whether or not the processing of steps S110 to S122 has been finished for all the chunk groups 210a. The rebuild processing program 422 ends the differential rebuilding processing at the time of the two-node failure, upon completion of the processing in steps S110 to S122 for all the chunk groups 210a (step S123 YES). On the other hand, the rebuild processing program 422 selects a new chunk group 210a in a case where there is a chunk group 210a for which the processing of steps S110 to S122 has not been finished (step S123 NO), and the processing returns to step S110.

### Second Embodiment

In the first embodiment described above, the failed nodes are sequentially recovered one by one at the time of two-node failure. However, recovery of the two failed nodes is not limited to be sequential recovery, and may be collective recovery. In a second embodiment, an example of collectively recovering two failed nodes will be described.

In the second embodiment, the description overlapping with the description of the first embodiment will be omitted.

### (Differential Rebuilding Processing at the Time of Two-Node Failure According to the Second Embodiment)

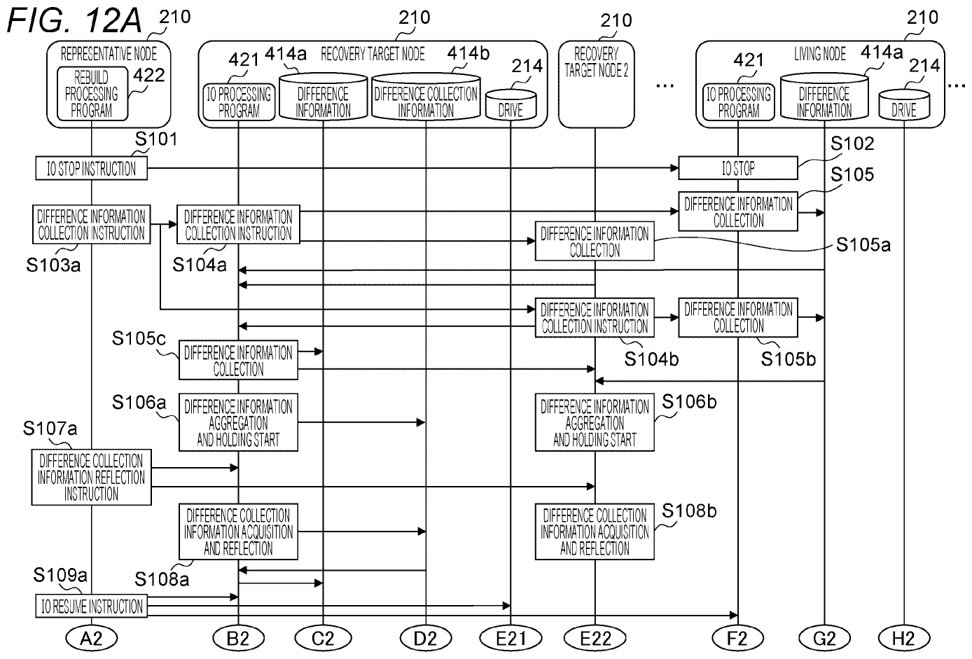

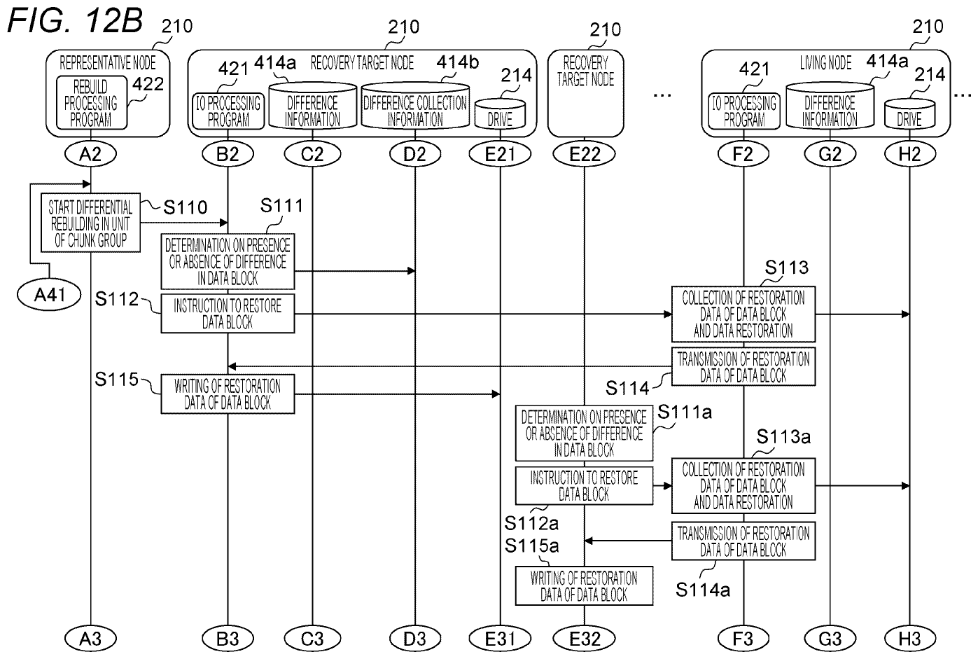

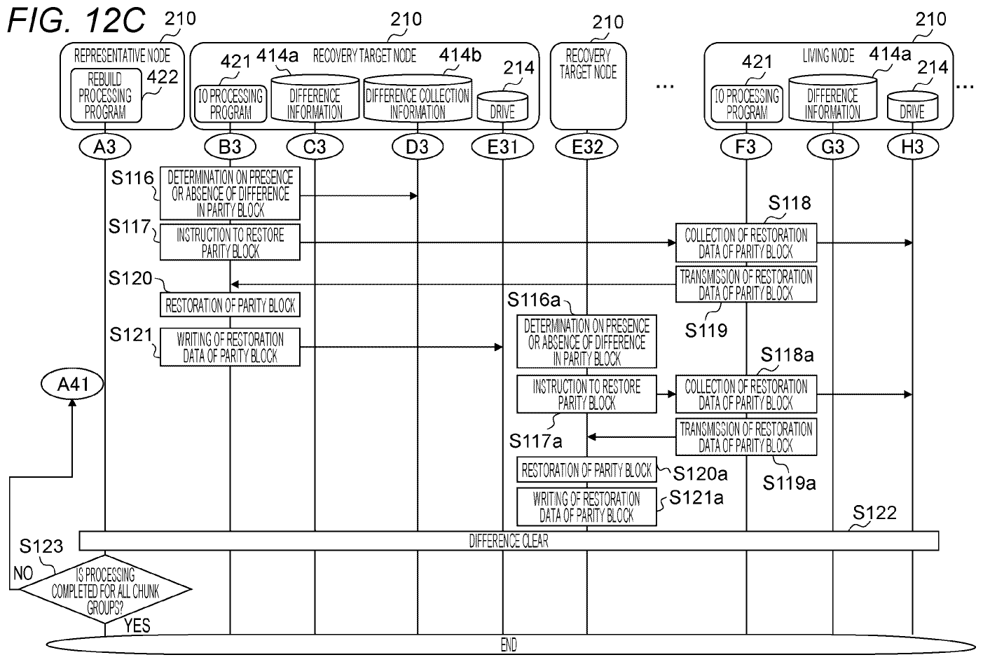

FIGS. 12 A, 12B, and 12 C are timing charts illustrating an example of differential rebuilding processing at the time of two-node failure according to the second embodiment.

The differential rebuilding processing at the time of two-node failure according to the second embodiment is different from the first embodiment in that the difference information collection instruction in step S103 is simultaneously output to two recovery nodes (the node 210 (the recovery target node 1) and the node 210 (the recovery target node 2)).

In step S103a subsequent to step S102, the rebuild processing program 422 of the node 210 (representative node) instructs the node 210 (recovery target node 1) and the node 210 (recovery target node 2) to perform difference collection.

Next, in step S104a, the IO processing program 421 of the node 210 (recovery target node 1) that has received the difference information collection instruction transmits the difference information collection instruction to the node 210 (recovery target node 2) and the nodes 210 (living nodes).

Next, in step S105, the IO processing programs 421 of the nodes 210 (living nodes) acquire and transmit the difference information 414a to the node 210 (recovery target node 1).

Further, in step S105a, the IO processing program 421 of the node 210 (recovery target node 2) acquires the difference information 414a in the node 210 (recovery target node 2) and transmits the difference information to the node 210 (recovery target node 1). At the time of execution of step S105a, the node 210 (recovery target node 2) has already recovered, and thus becomes a target of collection of difference information. However, at this time, since the node 210 (recovery target node 2) does not actually have the difference information, empty data (data in a state where there is no difference) is acquired as the difference information 414a.

Similarly, in step S104b, the IO processing program 421 of the node 210 (recovery target node 2) that has received the difference information collection instruction transmits the difference information collection instruction to the node 210 (recovery target node 1) and the nodes 210 (living nodes).

Next, in step S105b, the IO processing programs 421 of the nodes 210 (living nodes) acquire and transmit the difference information 414a to the node 210 (recovery target node 2).

Further, in step S105c, the IO processing program 421 of the node 210 (recovery target node 1) acquires the difference information 414a in the node 210 (recovery target node 1) and transmits the difference information to the node 210 (recovery target node 2). At the time of execution of step S105c, the node 210 (recovery target node 1) has already recovered, and thus becomes a target of collection of difference information. However, at this time, since the node 210 (recovery target node 1) does not actually have the difference information, empty data (data in a state where there is no difference) is acquired as the difference information 414a.

Next, in step S106a, the IO processing program 421 of the node 210 (recovery target node 1) aggregates the difference information received from the node 210 (recovery target node 2) and the nodes 210 (living nodes), and stores this information in the memory 212 as the difference collection information 414b. In step S106b, the IO processing program 421 of the node 210 (recovery target node 2) aggregates the difference information received from the node 210 (recovery target node 1) and the nodes 210 (living nodes), and stores this information in the memory 212 as the difference collection information 414b. By steps S106a and S106b, holding of the difference information necessary for rebuilding is started.

Next, in step S107a, the rebuild processing program 422 instructs the node 210 (recovery target node 1) and the node 210 (recovery target node 2) to reflect the difference information.

Next, in step S108a, the IO processing program 421 of the node 210 (recovery target node 1) acquires the difference collection information 414b in the node 210 (recovery target node 1) and reflects the difference collection information to the difference information 414a of the node 210 (recovery target node 1).

Further, in step S108b, the IO processing program 421 of the node 210 (recovery target node 2) acquires the difference collection information 414b in the node 210 (recovery target node 2) and reflects the difference collection information to the difference information 414a of the node 210 (recovery target node 2). After steps S108a and S108b, if there is another closed node in the storage system 101, recording of the difference information of the closed node is started.

In steps S111 to S115, the IO processing program 421 of the node 210 (recovery target node 1) executes restoration processing of the data block similar to that of the IO processing program 421 of the node 210 (recovery target node) of the first embodiment. Further, in steps S111a to S115a, the IO processing program 421 of the node 210 (recovery target node 2) executes the restoration processing of the data block similar to that of the IO processing program 421 of the node 210 (recovery target node) of the first embodiment.

In steps S116 to S121, the IO processing program 421 of the node 210 (recovery target node 1) executes restoration processing of the parity block similar to that of the IO processing program 421 of the node 210 (recovery target node) of the first embodiment. In addition, in steps S116a to S121a, the IO processing program 421 of the node 210 (recovery target node 2) executes the restoration processing of the parity block similar to that of the IO processing program 421 of the node 210 (recovery target node) of the first embodiment.

### Effects of Embodiment

In the above-described embodiment, in a case where the data block stored in the user area of the node is updated during a period in which this node is closed, the difference information related to the update in one node that is not closed and is normally operating out of two nodes other than the closed node. Therefore, even when two-node closure in which two nodes are simultaneously closed occurs, the differential rebuilding can be performed based on any piece of the difference information managed by the two nodes.

In addition, in the above-described embodiment, first, one of the two closed nodes is recovered. Thereafter, the difference information managed in the living nodes excluding the two closed nodes is collected as the first difference collection information, and the difference information managed in one of the nodes is restored based on the first difference collection information. Therefore, even if a different node is newly closed after the restoration of the difference information of the one node, two-node management of the difference information can be maintained.

In the above embodiment, after the difference information managed in one node is restored, if the first difference collection information indicates that there is a difference in the data block or the second parity stored in the one node, the data block or the second parity is restored by differential rebuilding. Therefore, in the embodiment, by immediately executing differential rebuilding to one node after the differential rebuilding of the one node, it is possible to accelerate the recovery from two-node closure to one-node closure, and to suppress deterioration of the fault tolerance of the storage system.

In addition, in the above-described embodiment, after restoration by differential rebuilding of the data block or the second parity stored in the one node is completed, only the difference information related to the data block and the second parity is cleared. Therefore, it is possible to maintain the difference information to prepare for the restoration of second one of the two closed nodes.

In addition, in the above-described embodiment, after the one node is restored, the restoration of the difference information, the differential rebuilding, and the clearing of difference information of the other node are performed. Therefore, since the closed nodes are sequentially recovered at the time of two-node closure, the node recovery can be performed even in a situation where the storage system is unstable where the situation changes from the two-node closure, to the one-node closure, and to the two-node closure.

In addition, in the above-described embodiment, the recovery, the differential rebuilding, and the clearing of the difference information of the two nodes in the two-node closure are simultaneously performed. Therefore, it is possible to quickly perform restoration of the nodes including data and difference information of the two nodes in the two-node closure.

In the above embodiment, each of the plurality of nodes holds the first parity and the difference information in the memory. Therefore, by the management with the two nodes, it is possible to prevent the loss of the difference information managed on the memory even when the two-node closure occurs.

In the above-described embodiment, the redundancy group is a stripe of MEC of mD+nP configured by including m of the data blocks and a parity including n of the first parities and the second parities, where m is an integer of 2 or more and is an integer of 2 or more. Therefore, the MEC that achieves both read/write performance and fault resistance of data further allows differential rebuilding to be performed even at the time of two-node closure.

Although some embodiments have been described above, these are examples for describing the present invention, and it is not intended to limit the scope of the present invention only to these embodiments. The present invention can be carried out in various other forms.

What is claimed is:

1. A storage system comprising:
four or more nodes each having a processor, a memory, and a storage drive, wherein
for user data stored in the storage drive, a redundancy group including a plurality of data blocks of the user data and a first parity and a second parity based on the plurality of data blocks is configured,
for each of the plurality of nodes, the storage drive of the corresponding node includes a user area that stores the plurality of data blocks belonging to different ones of the redundancy groups and a parity area that stores the second parity, and
the processor is configured to:
generate the second parity stored in the parity area of the corresponding node based on the first parity generated based on the plurality of data blocks belonging to the different redundancy groups stored in the user area of one of the nodes other than the corresponding node and on the plurality of data blocks belonging to an identical one of the redundancy groups stored in a distributed manner in the user areas of the plurality of nodes excluding the corresponding node and the one node;
manages difference information, by associating the plurality of data blocks stored in the user area and the first parity and the second parity stored in the parity area of the corresponding node, the difference information indicating presence or absence of a difference related to update of one or both of the data block and the second parity both belonging to the identical redundancy group with each of the data blocks, the first parity, and the second parity of the corresponding node; and
manages, in a case where the data block stored in the user area of the corresponding node is updated during a period in which the corresponding node is closed, the difference information related to the update in one node that is not closed and is normally operating out of two nodes other than the corresponding node.

2. The storage system according to claim 1, wherein
one of two closed nodes that are closed among the plurality of nodes is recovered,
after the recovery of the one node, the difference information managed in the plurality of nodes except the two closed nodes is collected as first difference collection information, and
the difference information managed in the one node is restored based on the collected first difference collection information.

3. The storage system according to claim 2, wherein
after the difference information managed in the one node is restored, in a case where the first difference collection information indicates that the difference exists in the data block stored in the user area or the second parity stored in the parity area of the one node, the data block or the second parity is restored by differential rebuilding.

4. The storage system according to claim 3, wherein
after completion of the restoration by the differential rebuilding of the data block stored in the user area or the second parity stored in the parity area of the one node, only the difference information related to the data block and the second parity is cleared.

5. The storage system according to claim 3, wherein
after the difference information related to the data blocks and the second parities managed in the plurality of nodes excluding the two closed nodes are cleared, the other of the two closed nodes that is not the one node is recovered,
after the recovery of the other node, the difference information managed in the plurality of nodes excluding the other node is collected as second difference collection information,
the difference information managed in the other node is restored based on the collected second difference collection information,
after the restoration of the difference information managed in the other node, in a case where the second difference collection information indicates that the difference exists in the data block stored in the user area or the second parity stored in the parity area of the other node, the data block or the second parity is restored by differential rebuilding, and
after completion of the restoration by the differential rebuilding of the data block stored in the user area or the second parity stored in the parity area of the other node, the difference information related to the data blocks and the second parities managed in the plurality of nodes excluding the two closed nodes is cleared.

6. The storage system according to claim 1, wherein
a first node and a second node that are closed among the plurality of nodes are simultaneously recovered,
in the first node, the difference information managed in the plurality of nodes excluding the first node is collected as first difference collection information,
the difference information managed in the first node is restored based on the collected first difference collection information,
after the restoration of the difference information managed in the first node, in a case where the first difference collection information indicates that the difference exists in the data block stored in the user area or the second parity stored in the parity area of the first node, the data block or the second parity is restored by differential rebuilding,
in the second node, the difference information managed in the plurality of nodes excluding the second node is collected as second difference collection information,
the difference information managed in the second node is restored based on the collected second difference collection information,
after the restoration of the difference information managed in the second node, in a case where the second difference collection information indicates that the difference exists in the data block stored in the user area or the second parity stored in the parity area of the second node, the data block or the second parity is restored by differential rebuilding, and
after completion of the restoration by the differential rebuilding of the data block stored in the user area or the second parity stored in the parity area of each of the first node and the second node, the difference information related to the data blocks and the second parities managed in the plurality of nodes excluding the first node and the second node is cleared.

7. The storage system according to claim 1, wherein
each of the plurality of nodes holds the first parity and the difference information in the memory.

8. The storage system according to claim 1, wherein
the redundancy group is a stripe of erasure coding of mD+nP configured by including m of the data blocks and a parity including n of the first parities and the second parities, where m is an integer of 2 or more and n is an integer of 2 or more.

9. A data difference management method for a storage system including four or more nodes each having a processor, a memory, and a storage drive, wherein
for user data stored in the storage drive, a redundancy group including a plurality of data blocks of the user data and a first parity and a second parity based on the data blocks is configured,
for each of the plurality of nodes, the storage drive of the corresponding node includes a user area that stores the plurality of data blocks belonging to different ones of the redundancy groups and a parity area that stores the second parity, and
the method causes the processor to perform processing of:
generating the second parity stored in the parity area of the corresponding node based on the first parity generated based on the plurality of data blocks belonging to the different redundancy groups stored in the user area of one of the nodes other than the corresponding node and on the plurality of data blocks belonging to an identical one of the redundancy groups stored in a distributed manner in the user areas of the plurality of nodes excluding the corresponding node and the one node;
managing difference information, by associating the plurality of data blocks stored in the user area and the first parity and the second parity stored in the parity area of the corresponding node, the difference information indicating presence or absence of a difference related to update of one or both of the data block and the second parity both belonging to the identical redundancy group with each of the data blocks, the first parity, and the second parity of the corresponding node; and
managing, in a case where the data block stored in the user area of the corresponding node is updated during a period in which the corresponding node is closed, the difference information related to the update in one node that is not closed and is normally operating out of two nodes other than the corresponding node.
